(19) United States
(12) Patent Application Publication
(10) Pub. No.: US 2016/0321090 A1
(43) Pub. Date: Nov. 3, 2016

(54) SELECTIVELY LOADING A SET OF MODULES

(71) Applicant: YANDEX EUROPE AG, Luzern (CH)

(72) Inventor: Sergey Sergeevich KONSTANTINOV, Moscow (RU)

(21) Appl. No.: 15/108,650

(22) PCT Filed: Dec. 1, 2014
(86) PCT No.: PCT/IB2014/066487

§ 371 Date: Jun. 28, 2016

(30) Foreign Application Priority Data
May 29, 2014 (RU) 2014122129

(51) Int. Cl. G06F 9/445; G06F 9/50; G06F 17/50

(52) U.S. Cl. CPC G06F 9/44521; G06F 17/50; G06F 9/445; G06F 9/5016

(57) ABSTRACT

Method, electronic device, and computer-readable medium storing program instructions for selectively loading a set of modules nominally required by a first module for processing a potential set of objects, the method comprising: receiving an indication of an actual set of objects to be processed using the first module, the actual set of objects being a proper subset of the potential set of objects; performing an analysis of the members of the actual set of objects; based on the analysis, identifying a relevant set of modules actually required by the first module for processing the actual set of objects, the relevant set of modules being a proper subset of the set of modules; and loading, from a first memory to a second memory, only those members of the set of modules that are also members of the relevant set of modules.

### CROSS-REFERENCE

The present application claims convention priority to Russian Patent Application No. 2014122129, filed May 29, 2014, entitled “SYSTEM AND METHOD FOR SELECTIVELY LOADING A SET OF MODULES” which is incorporated by reference herein in its entirety.

### FIELD

The present technology relates to systems and methods for selectively loading a set of modules nominally required by a first module.

### BACKGROUND

Modern computing devices generally contain more than one type of memory. Memory can be broadly categorized into two types: (1) low-latency execution memory in which program instructions may be directly and efficiently executed by a processor, such as random access memory (RAM); and (2) high-latency storage memory in which program instructions cannot be efficiently executed by a processor, but in which they may be stored and from which they may be loaded into low-latency memory for subsequent efficient execution, such as a hard disk drive (HDD).

This division of memory resources into different types arises because each type presents respective advantages and disadvantages rendering them suitable for different tasks. In particular, lower latency memory tends to have a significantly higher cost per unit of storage than does higher latency memory.

Because there are considerable cost pressures on the manufacture of modern computing devices, it is desirable to minimize requirements for low-latency memory as much as possible. Modern computing devices therefore generally store program instructions in high-latency storage memory, copy (load) them to low-latency execution memory only when their execution by the processor is anticipated, and then unload them—by relinquishing the consumed low-latency memory space—when their execution has completed or is no longer anticipated. Computing devices which load and unload program instructions in this manner may require a lesser amount of relatively expensive low-latency memory, thus reducing overall cost of manufacture.

One way that the efficiency of memory usage may be increased is to design computer programs to operate in a modular fashion, meaning that program instructions which implement functionality common to a number of computer programs may be stored in a set of one or more modules or libraries to which each computer program may be linked, such that these program instructions need only be stored once (in the set of modules) instead of being redundantly included in each computer program.

Conventionally, the modules on which a computer program depends may be loaded from high-latency memory into low-latency memory either statically or dynamically. Static loading refers to automatically loading, at the time the computer program itself is initially loaded, all modules on which the computer program is nominally dependent; that is to say, all modules which may be required by any instance of the computer program to successfully handle any potential state or circumstance which that computer program may encounter. Dynamic loading, on the other hand, refers to loading one or more of the modules at runtime based on an explicit program instruction of the computer program. For example, a computer game which allows a user to play either a game of checkers or a game of chess game may nominally require both a checkers module and a chess module in order to successfully handle all potential user interactions, even though the user may ultimately decide only to play checkers. Under a static loading paradigm, both the checkers module and the chess module would be loaded into low-latency memory upon initial loading of the computer game. Alternatively, under a dynamic loading paradigm, the computer game could have been programmed to load neither the checkers module nor the chess module initially, but then explicitly load the checkers module when the program reaches a state wherein the user has chosen to play checkers.

Static and dynamic loading each present advantages and disadvantages. In the case of static loading, the main advantage lies in the guarantee that all modules that may be needed are already available in the low-latency memory, thus ensuring that the computer program is responsive; however, this advantage comes at the expense of a potentially unnecessarily large low-latency memory footprint, since all of the modules are automatically loaded, potentially including some (or many) whose program instructions are never actually executed. Conversely, dynamic loading provides the advantage of a potentially lesser memory footprint, but the disadvantage of potentially sluggish performance upon first use of each module, as there may be a noticeable delay associated with loading the module from high-latency memory.

Various techniques are known for striking a middle ground between completely static or completely dynamic loading, whereby modules are normally stored in high-latency storage memory and then “preloaded” into low-latency execution memory based on an anticipated need for the functionality their program instructions implement. For example, a method of preloading dynamically loading modules is described in International Publication Number WO 2009/083732 A1, “Preloading Dynamic Link Libraries” (hereinafter “Roe”). As disclosed therein, a computer program may have a “soft dependency” on one or more dynamic link libraries (DLLs), meaning that the computer program may only sometimes need to execute program instructions included in those DLLs. Such soft dependencies contrasts with the “hard” dependency of a computer program on those modules which are required by every instance of the program, no matter what particular circumstances arise at runtime. Roe describes a method of dynamically loading one or more modules upon which the computer program is softly dependent based on detected occurrences of particular “events” believed to be indicative of an anticipated need for particular functionality implemented by those modules. Various types of events are described, including transceiver events (e.g. receiving data via a network), user interface events (e.g. mouse clicks), and clock events (e.g. it is Saturday night).

More generally, a method and system for preloading resources before they are needed by a computer program is described in US Patent Publication Number US 2003/0220984 A1, “Method and System for Preloading Resources” (hereinafter “Jones”). Resources are preloaded based on an indication of a state of the computer program called an “application hint” which is fed to a prediction model used to anticipate which resources may be needed on the basis of computer program state information. The term “resources” is broadly defined in Jones as “any data an application uses for execution”, and examples provided include a file or portion of a file such as a dynamic link library, an executable file, or a component.

### SUMMARY

While systems and methods for conditionally loading modules such as Roe and Jones are known, these rely on an appreciation of state information, such as “events” in Roe or “application hints” in Jones.

The present technology provides for a different basis upon which modules nominally required by a first module of a computer program may be selectively loaded. Instead of state information, implementations of the present technology identify a subset of modules to be loaded on the basis of an analysis of actual data to be processed.

Thus, in one aspect, various implementations of the present technology provide a computer-implemented method for selectively loading a set of modules nominally required by a first module for processing a potential set of objects, the method comprising:
(a) receiving an indication of an actual set of objects to be processed using the first module, the actual set of objects being a proper subset of the potential set of objects;
(b) performing an analysis of the members of the actual set of objects;
(c) based on the analysis, identifying a relevant set of modules actually required by the first module for processing the actual set of objects, the relevant set of modules being a proper subset of the set of modules; and
(d) loading, from a first memory to a second memory, only those members of the set of modules that are also members of the relevant set of modules.

In another aspect, various implementations of the present technology provide an electronic device configured to selectively load a set of modules nominally required by a first module for processing a potential set of objects, the device comprising: a processor; and a first memory and a second memory each operatively coupled to the processor, the first memory storing the first module, the set of modules, and program instructions executable by the processor to effect:
(a) reception of an indication of an actual set of objects to be processed using the first module, the actual set of objects being a proper subset of the potential set of objects;
(b) performance of an analysis of the members of the actual set of objects;
(c) identification, based on the analysis, of a relevant set of modules actually required by the first module for processing the actual set of objects, the relevant set of modules being a proper subset of the set of modules; and
(d) loading, from the first memory to the second memory, of only those members of the set of modules that are also members of the relevant set of modules.

In another aspect, various implementations of the present technology provide a non- transitory computer-readable medium storing program instructions for selectively loading a set of modules nominally required by a first module for processing a potential set of objects, the program instructions being executable by a processor of an electronic device to effect:
(a) reception of an indication of an actual set of objects to be processed using the first module, the actual set of objects being a proper subset of the potential set of objects;
(b) performance of an analysis of the members of the actual set of objects;
(c) identification, based on the analysis, of a relevant set of modules actually required by the first module for processing the actual set of objects, the relevant set of modules being a proper subset of the set of modules; and
(d) loading, from the first memory to the second memory, of only those members of the set of modules that are also members of the relevant set of modules.

In some implementations of any of the above-described aspects, receiving the indication of the actual set of objects to be processed using the first module comprises receiving an instruction to load the first module, the instruction including the indication of the actual set of objects to be processed using the first module.

In some implementations of any of the above-described aspects, at least one object of each one of a plurality of types is a member of the potential set of objects, the actual set of objects excludes all members of the potential set of objects of at least one of the types, performing the analysis of the members of the actual set of objects comprises determining a type of each object being a member of the actual set of objects, and identifying the relevant set of modules comprises identifying, as the relevant set of modules, those members of the set of modules that include program instructions relevant for processing objects of each one of the types other than the at least one of the types.

In some such implementations, identifying those members of the set of modules that include program instructions relevant for processing objects of each one of the types other than the at least one of the types comprises appreciating a predefined mapping from each one of the types to a respective set of modules relevant for processing objects of that one of the types.

In some such implementations, the at least one object comprises at least one file, the plurality of types comprises a plurality of file formats, the potential set of objects comprises a potential set of files, the actual set of objects comprises an actual set of files excluding all members of the potential set of files of at least one of the file formats, performing the analysis of the members of the actual set of objects comprises determining a file format of each file being a member of the set of the actual set of files, and identifying the relevant set of modules comprises identifying, as the relevant set of modules, those members of the set of modules that include program instructions relevant for processing files of each one of the file formats other than the at least one of the file formats.

In some such implementations, the at least one object comprises at least one geometry object, the plurality of types comprises a plurality of geometries, the potential set of objects comprises a potential set of geometry objects, the actual set of objects comprises an actual set of geometry objects excluding all members of the potential set of geometry objects of at least one of the geometries, performing the analysis of the members of the actual set of objects comprises determining a geometry of each geometry object being a member of the set of the actual set of geometry objects, and identifying the relevant set of modules comprises identifying, as the relevant set of modules, those members of the set of modules that include program instructions relevant for processing geometry objects of each one of the geometries other than the at least one of the geometries.

In some such implementations, the at least one object comprises at least one computer-aided design object, the plurality of types comprises a plurality of computer-aided design object types, the potential set of objects comprises a potential set of computer-aided design objects, the actual set of objects comprises an actual set of computer-aided design objects excluding all members of the potential set of computer-aided design objects of at least one of the computer-aided design object types, performing the analysis of the members of the actual set of objects comprises determining a computer-aided design object type of each computer-aided design object being a member of the set of the actual set of computer-aided design objects, and identifying the relevant set of modules comprises identifying, as the relevant set of modules, those members of the set of modules that include program instructions relevant for processing computer-aided design objects of each one of the computer-aided design object types other than the at least one of the computer-aided design object types.

In some such implementations, the at least one object comprises at least one graphical object, the plurality of types comprises a plurality of graphical object types, the potential set of objects comprises a potential set of graphical objects, the actual set of objects comprises an actual set of graphical objects excluding all members of the potential set of graphical objects of at least one of the graphical object types, performing the analysis of the members of the actual set of objects comprises determining a graphical object type of each graphical object being a member of the set of the actual set of graphical objects, and identifying the relevant set of modules comprises identifying, as the relevant set of modules, those members of the set of modules that include program instructions relevant for processing graphical objects of each one of the graphical object types other than the at least one of the graphical object types.

In some such implementations, the at least one object comprises at least one mathematical formula, the plurality of types comprises a plurality of mathematical formula types, the potential set of objects comprises a potential set of mathematical formulas, the actual set of objects comprises an actual set of mathematical formulas excluding all members of the potential set of mathematical formulas of at least one of the mathematical formula types, performing the analysis of the members of the actual set of objects comprises determining a mathematical formula type of each mathematical formula being a member of the set of the actual set of mathematical formulas, and identifying the relevant set of modules comprises identifying, as the relevant set of modules, those members of the set of modules that include program instructions relevant for processing mathematical formulas of each one of the mathematical formula types other than the at least one of the mathematical formula types.

In some such implementations, the at least one object comprises at least one database request, the plurality of types comprises a plurality of database request types, the potential set of objects comprises a potential set of database requests, the actual set of objects comprises an actual set of database requests excluding all members of the potential set of database requests of at least one of the database request types, performing the analysis of the members of the actual set of objects comprises determining a database request type of each database request being a member of the set of the actual set of database requests, and identifying the relevant set of modules comprises identifying, as the relevant set of modules, those members of the set of modules that include program instructions relevant for processing database requests of each one of the database request types other than the at least one of the database request types.

In the context of the present specification, unless expressly provided otherwise, an “electronic device” is any hardware and/or software appropriate to the relevant task at hand. Thus, some non-limiting examples of electronic devices include computers (servers, desktops, laptops, netbooks, etc.), smartphones, and tablets, as well as network equipment such as routers, switches, and gateways.

In the context of the present specification, unless expressly provided otherwise, the expression “computer-readable medium” is intended to include media of any nature and kind whatsoever, non-limiting examples of which include RAM, ROM, disks (CD-ROMs, DVDs, floppy disks, hard disk drives, etc.), USB keys, flash memory cards, solid state-drives, and tape drives.

In the context of the present specification, unless expressly provided otherwise, an “indication of” an information element may be the information element itself or a pointer, reference, link, or other indirect mechanism enabling the recipient of the indication to locate a network, memory, database, or other computer-readable medium location from which the information element may be retrieved. For example, an indication of a file could include the file itself (i.e. its contents), or it could be a unique file descriptor identifying the file with respect to a particular filesystem, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

In the context of the present specification, unless expressly provided otherwise, certain claim elements have been labeled with letters “(a)”, “(b)”, “(c)”, etc. These labels have been used only for ease of reference to the claim elements to which they refer, and not for the purpose of describing any particular relationship between those claim elements. The alphabetical nature of these labels is not intended to necessarily imply and should not be used to construe the claim elements to be in any particular order, chronology, hierarchy or ranking between the claim elements. Thus, for example, depending on the implementation, a method claim element with the label “(d)” may occur before, after, or simultaneously with a method claim element with the label “(b)”.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a diagram of a computer system including various hardware components, suitable for implementing the present technology and/or being used in conjunction with implementations of the present technology;

FIG. 2 is a conceptual block diagram illustrating a potential set of objects and an actual set of objects according to an implementation of the present technology;

FIG. 3 is a conceptual block diagram illustrating a set of modules nominally required by a first module and a relevant set of modules actually required by the first module in accordance with the actual set of objects of FIG. 2, according to an implementation of the present technology; and

FIG. 4 is a flowchart illustrating a method being implemented within the computer system of FIG. 1, the method being implemented according to a non-limiting embodiment of the present technology.

### DETAILED DESCRIPTION

It should be noted that all examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included. Software modules, or simply modules which are implied to be software, may be represented herein as any combination of flowchart elements or other elements indicating performance of process steps and/or textual description. Such modules may be executed by hardware that is expressly or implicitly shown.

Finally, it should also be noted that, unless otherwise explicitly specified herein, the drawings are not to scale.

With these fundamentals in place, we will now consider some non-limiting examples to illustrate various implementations of aspects of the present technology.

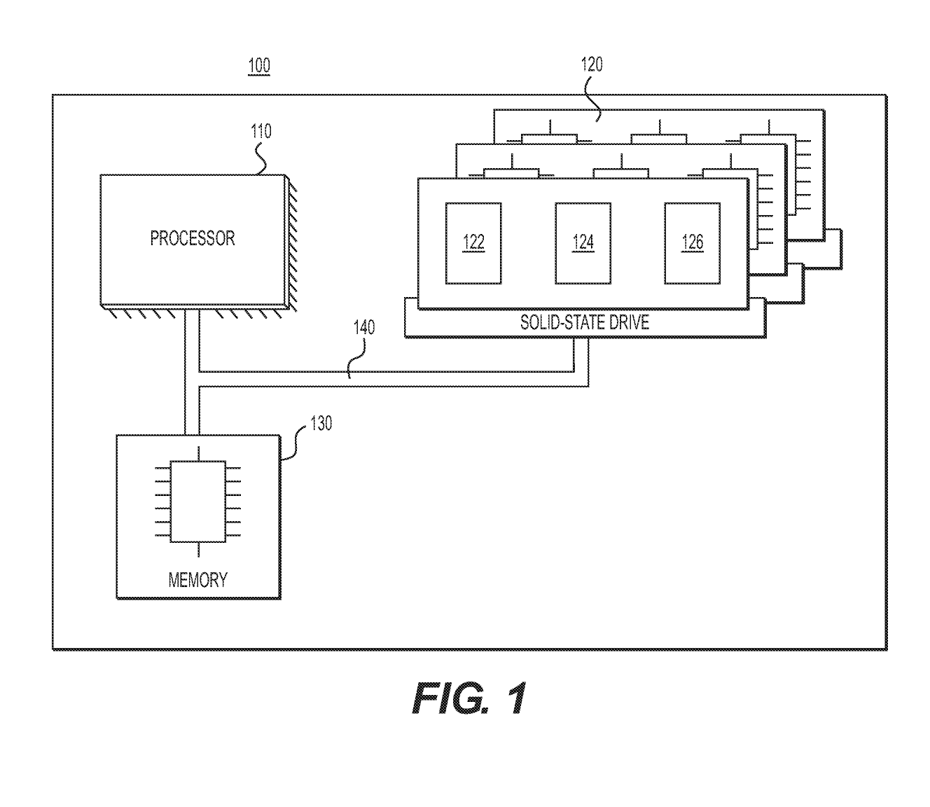

Referring to FIG. 1, there is shown an implementation of the present technology in the form of a computer system 100 including various hardware components: one or more single or multi-core processors collectively represented by processor 110, a solid-state drive 120, and a random access memory 130. Communication between the various components of the computer system 100 is enabled by one or more internal and/or external buses 140 (e.g. a PCI bus, universal serial bus, IEEE 1394 “Firewire” bus, SCSI bus, Serial-ATA bus, etc.), to which the components are electronically coupled.

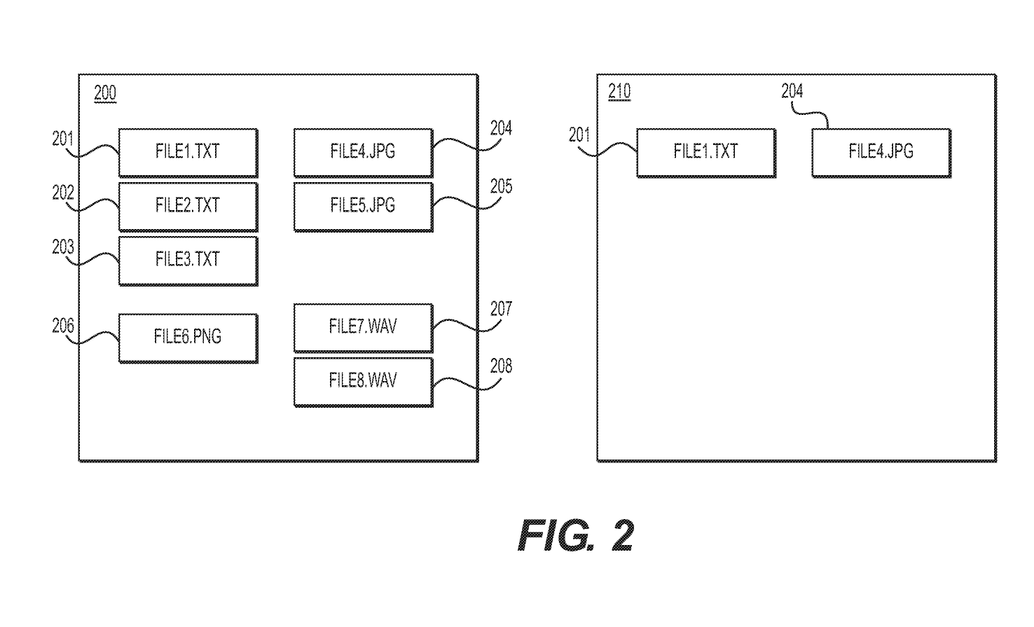

According to embodiments of the present technology, the solid-state drive 120 stores a first module 122, a set of modules 124 nominally required by the first module 122 for processing a potential set of objects (an example of which is depicted in FIG. 2), and program instructions 126 executable by processor 110 to selectively load members of the set of modules 124 on the basis of a runtime analysis of an actual set of objects (an example of which is depicted in FIG. 2) to be processed by the first module 122. It should be understood that, while the first module 122 and the program instructions 126 have been depicted as separate entities in FIG. 1, in other implementations, the first module 122 may comprise the program instructions 126. Moreover, the first module 122 may in some implementations be stored together with and/or as part of the set of modules 124.

With reference to FIG. 2, a potential set of objects 200 and actual set of objects 210 are shown according to one implementation of the technology. In the depicted implementation, the potential set of objects 200 is a set of files 201 to 208, each one of the set of files 201 to 208 being of one of the following types/file formats: text (TXT), JPEG image (JPG), PNG image (PNG), and WAV audio (WAV). The actual set of objects 210 is a proper subset of the set of files 201 to 208, including only file 201 (“FILE1.TXT”) and file 204 (“FILE4.JPG”). The actual set of objects 210 thus excludes all of the objects included in the potential set of objects 200 of the PNG and WAV file formats (i.e. the actual set of objects 210 excludes those of the set of files enumerated with 206, 207 and 208).

Obviously, file formats other than those shown in FIG. 2 may be included in other implementations. Moreover, the file format of the files need not be indicated by a three-letter extension of the filename. In some implementations, the file format may be indicated by an explicit tag contained in the file. In some implementations, the file format may be implicit and only determinable via an inspection and analysis of the file's contents. Furthermore, it should be expressly understood that neither the potential set of objects 200 nor the actual set of objects 210 should be limited to the number of respective objects contained therein to those depicted in FIG. 2.

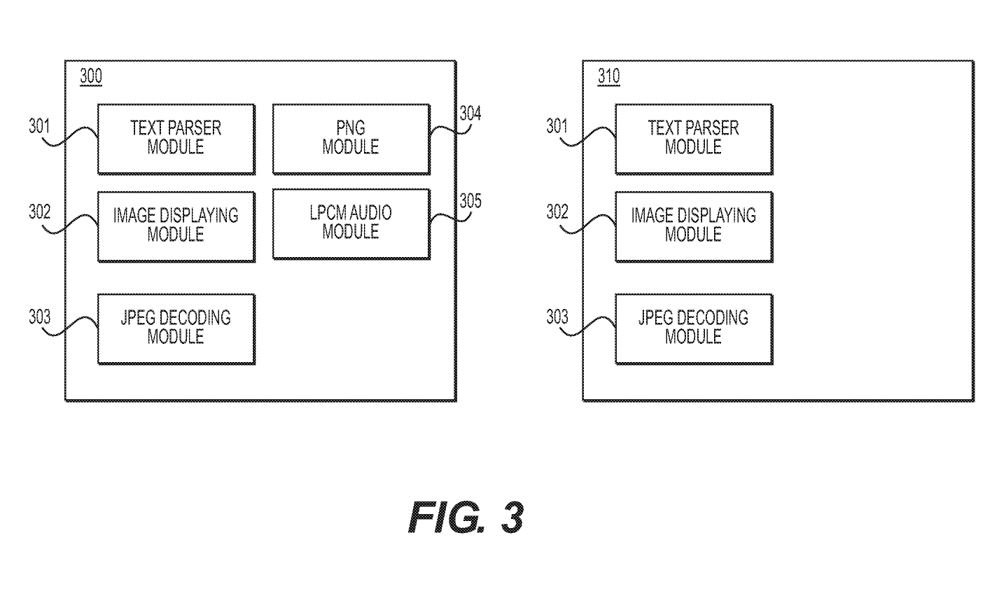

Turning to FIG. 3, there is shown a set of modules 300 and a relevant set of modules 310 for use with an implementation of the present technology. For example, the set of modules 300 may consist of those being nominally required for processing the potential set of objects 200 of FIG. 2, and the relevant set of modules 310 may consist of those actually being required for processing the actual set of objects 210 of FIG. 2. In other words, the relevant set of modules 310 is a subset of the set of modules 300, the relevant set of modules 310 being actually required for processing the actual set of objects 210 being a subset of the potential set of objects 200.

As depicted, the set of modules 300 includes a text parser module 301 for manipulating text files (e.g. files 201, 202, 203), an image displaying module 302 for causing images contained in image files (e.g. 204, 205, 206) to be displayed on a display (not depicted), a JPEG decoding module 303 for decoding image files encoded according to a Joint Photographic Experts Group standard (e.g. 204, 205), a PNG module 304 for parsing Portable Network Graphics files such as file 206 and extracting the images they contain, and an LPCM audio module 305 for manipulating Linear Pulse Code Modulation audio data contained in WAV files (e.g. 207, 208).

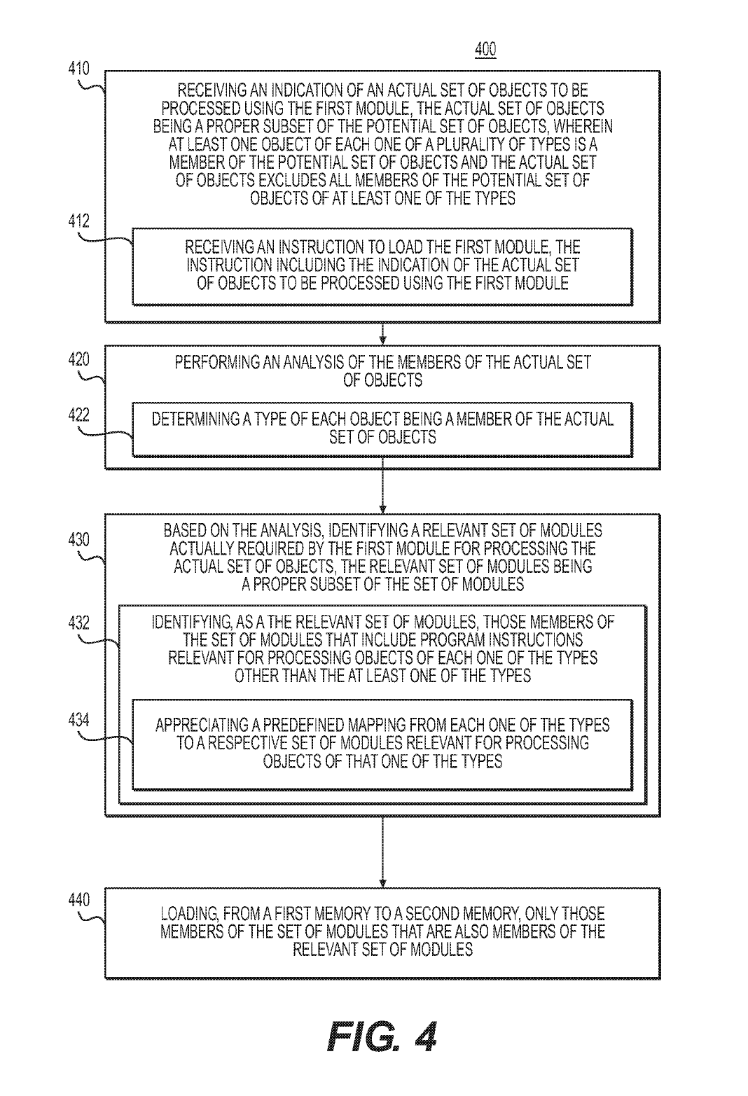

With reference now to FIG. 4, a flowchart corresponding to an exemplary method implementation of the present technology is shown. More specifically, FIG. 4 shows a computer-implemented method 400 for selectively loading a set of modules nominally required by a first module 122 for processing a potential set of objects 210. Method 400 may be carried out, for example, in the context of the computer system 100 of FIG. 1 by executing the program instructions 126 using processor 110 to selectively load members of the set of modules 124 nominally required by the first module 122. The program instructions 126 may be included in a computer program (not depicted) having been loaded from the solid-state drive 120 into the random access memory 130 and being executed by the processor 110.

In response to a condition, the computer program may need to process a set of objects (e.g. files), and the first module 122 may include program instructions which implement functionality relevant to the processing of those objects. The computer program may therefore dynamically load the first module 122 from the solid-state drive 120 into the random access memory 130 in order to avail itself of that relevant functionality. For example, the computer program may be a file indexing application which is called upon to analyze a variety of files, and the first module 122 may be a file analysis module including program instructions executable by processor 110 to perform a variety of file analysis operations in respect of files of various file formats.

Because the first module 122 may be designed to process a broad variety of objects (e.g. analyze files of a variety of file formats), the first module 122 may itself be designed to make use of a set of modules 124 each implementing specific functionality in respect of objects of one or more particular types (e.g. files of one or more file formats). In order for the first module 122 to be able to process objects of all of the types, all of the members of the set of modules 124 would first need to be loaded. In this sense, the set of modules 124 is nominally required by the first module 122 for processing the entirety of the potential set of objects 200. However, since the actual set of objects 210 which the first module 122 actually ends up being called upon to process may not include objects of all of the types in the potential set of objects 200, it may be unnecessary and wasteful of scarce memory resources to load all of the members of the set of modules 124. In like context, it may be advantageous to carry out method 400 to selectively load only some of the modules in the set of modules 124, as follows.

At step 410, an indication of the actual set of objects 210 to be processed using the first module 122 is received, the actual set of objects 210 being a proper subset of the potential set of objects 200, at least one object of each one of a plurality of types being a member of the potential set of objects 200 and the actual set of objects 210 excluding all members of the potential set of objects 200 of at least one of the types.

For example, the potential set of objects 200 may be files of a plurality of file formats, which includes files 201 to 208 of four different file formats (TXT, JPG, PNG, WAV), and the actual set of objects 210 of FIG. 2, which includes files 201 and 204 of only two types (TXT, JPG). Therefore, the actual set of objects 210 excludes members of the file types PNG and WAV. The indication of the actual set of objects 210 to be processed may be, for example, a data structure (array, linked list, hash table, object-oriented object, etc.) containing the objects, or a pointer or reference to such a data structure, or any other suitable indication.

In some implementations, step 410 comprises step 412, wherein an instruction to load the first module 122 is received, the instruction including the indication of the actual set of objects to be processed using the first module 122. For example, the first module 122 could be a DLL for analyzing file contents of files of a variety of file formats, and the instruction could be an instruction to dynamically load the DLL. However, unlike a conventional instruction to load a DLL, the instruction would include an indication of a set of objects to be processed using the DLL, such as the actual set of objects 210 of FIG. 2, consisting of files 201 and 204.

At step 420, an analysis of the members of the actual set of objects 210 is performed. In some implementations, step 420 includes step 422, wherein a type of each object being a member of the actual set of objects 210 is determined For example within the example of the actual set of objects 210, the type of each object may be the file format of each file being a member of the actual set of objects 210, namely files 201 and 204.

At step 430, a relevant set of modules 310 actually required by the first module 122 for processing the actual set of objects 210 is identified based on the analysis performed at step 420, the relevant set of modules 310 being a proper subset of the set of modules 300. For example, the relevant set of modules for processing the actual set of modules 210 of FIG. 2 may be identified as the relevant set of modules 310 of FIG. 3, which is a proper subset of the set of modules 300 nominally required by the first module 122 to process all of the members of the potential set of objects 200.

In some implementations, step 430 comprises step 432, wherein the relevant set of modules 310 is identified as those members of the set of modules 310 that include program instructions relevant for processing objects of each one of the types other than the at least one of the types of the set of modules 300 not included in the relevant set of modules 310. In other words, the relevant modules are identified as those which relate to processing objects of the types actually included in the set of objects 210 to be processed using the first module 122, to the exclusion of any modules relevant only for processing objects of types not represented in the actual set of objects 210.

In some implementations, step 432 comprises step 434, wherein a predefined mapping from each one of the types to a respective set of modules relevant for processing objects of that one of the types is appreciated. Non-limiting examples of ways such a predefined mapping may be defined include hard-coding the mapping into the program instructions 126, hard-coding the mapping into program instructions of the first module 122, and including the mapping in a configuration file accompanying either the program instructions 126 or the first module 122.

At step 440, only those members of the set of modules 124 that are also members of the relevant set of modules are loaded from a first memory (e.g. solid-state drive 120) to a second memory (e.g. random access memory 130). In other words, of members of the set of modules 124 nominally required by the first module 122, only those identified at step 430 as relevant for processing of the actual set of objects 210 by the first module 122 are actually loaded. For example, for the actual set of objects 210 of FIG. 2, consisting only of the text file 201 and JPEG image file 204, the relevant set of modules 310 of FIG. 3 consisting only of the text parser module 301, the image displaying module 302, and the JPEG decoding module may be loaded, since there is no need to load either the PNG module 304 or the LPCM audio module 305 given that the PNG file 206 and both of the WAV files 207 and 208 are not among the actual set of objects 210 to be processed by the first module 122.

As those skilled in the art will readily understand, in other implementations, the objects to be processed by the module may be of a nature other than files, and the types of those objects may be of a nature other than file types. A series of non-limiting examples is provided below.

In some implementations, the objects may be geometry objects each having a geometry. For example, the geometry objects may be defined in a file according to the GeoJSON format. There could be many different geometries each potentially requiring the functionality of specialized modules for processing geometry objects having those geometries. Thus, when a module for handling geometry objects is loaded, it could be provided with an actual set of geometry objects that it will be called upon to process, and if any geometries are not represented in the actual set of geometry objects, the specialized modules for handling those geometries need not be loaded.

Similarly, in some implementations, the objects may be computer-aided design (CAD) objects each being of a CAD object type. Some CAD projects make use of only some CAD object types. Upon loading a module for processing CAD objects, a particular CAD project could be provided in order to assess the actual set of CAD objects it contains and thus avoid loading specialized modules nominally required by the module for processing CAD object types which are not present in the particular CAD project.

In some implementations, the objects may be graphical objects each being of a graphical object type. Various image files may contain graphical objects of various types. A module for processing image files in general may nominally require several modules in order to process all of the graphical object types that may be present in the image file. By analyzing the image file at runtime, the absence of one or more of the graphical object types would obviate the need to load any modules only required to process graphical objects of those types.

In some implementations, the objects may be mathematical formulas each being of a mathematical formula type. For example, a large variety of mathematical formulas of various types may hypothetically be present in a spreadsheet, but most spreadsheets make use of just a few. Rather than load modules for processing mathematical formulas of all of the mathematical formula types which could potentially be present in a spreadsheet, only those modules required to process the mathematical formulas actually present in a spreadsheet may be loaded.

In some implementations, the objects may be database requests each being of a database request type. Database requests can potentially invoke a large range of functions for interacting with a database, many of which may be implemented in specialized modules. Yet some database requests may require only a narrow subset of the full potential range of functions for interacting with the database. By analyzing a database request at runtime, it may become evident that a database module will only require some of the modules on which it nominally depends in order to process the database request.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A computer-implemented method for selectively loading a set of modules nominally required by a first module for processing a potential set of objects, the method comprising:
(a) receiving an indication of an actual set of objects to be processed using the first module, the actual set of objects being a proper subset of the potential set of objects;
(b) performing an analysis of the members of the actual set of objects;
(c) based on the analysis, identifying a relevant set of modules actually required by the first module for processing the actual set of objects, the relevant set of modules being a proper subset of the set of modules; and
(d) loading, from a first memory to a second memory, only those members of the set of modules that are also members of the relevant set of modules.

2. The computer-implemented method of claim 1, wherein (a) comprises receiving an instruction to load the first module, the instruction including the indication of the actual set of objects to be processed using the first module.

3. The computer-implemented method of claim 1, wherein at least one object of each one of a plurality of types is a member of the potential set of objects, the actual set of objects excludes all members of the potential set of objects of at least one of the types, (b) comprises determining a type of each object being a member of the actual set of objects, and (c) comprises identifying, as the relevant set of modules, those members of the set of modules that include program instructions relevant for processing objects of each one of the types other than the at least one of the types.

4. The computer-implemented method of claim 3, wherein identifying those members of the set of modules that include program instructions relevant for processing objects of each one of the types other than the at least one of the types comprises appreciating a predefined mapping from each one of the types to a respective set of modules relevant for processing objects of that one of the types.

5. The computer-implemented method of claim 3, wherein the at least one object comprises at least one file, the plurality of types comprises a plurality of file formats, the potential set of objects comprises a potential set of files, the actual set of objects comprises an actual set of files excluding all members of the potential set of files of at least one of the file formats, (b) comprises determining a file format of each file being a member of the set of the actual set of files, and (c) comprises identifying, as the relevant set of modules, those members of the set of modules that include program instructions relevant for processing files of each one of the file formats other than the at least one of the file formats.

6. The computer-implemented method of claim 3, wherein the at least one object comprises at least one geometry object, the plurality of types comprises a plurality of geometries, the potential set of objects comprises a potential set of geometry objects, the actual set of objects comprises an actual set of geometry objects excluding all members of the potential set of geometry objects of at least one of the geometries, (b) comprises determining a geometry of each geometry object being a member of the set of the actual set of geometry objects, and (c) comprises identifying, as the relevant set of modules, those members of the set of modules that include program instructions relevant for processing geometry objects of each one of the geometries other than the at least one of the geometries.

7. The computer-implemented method of claim 3, wherein the at least one object comprises at least one computer-aided design object, the plurality of types comprises a plurality of computer-aided design object types, the potential set of objects comprises a potential set of computer-aided design objects, the actual set of objects comprises an actual set of computer-aided design objects excluding all members of the potential set of computer-aided design objects of at least one of the computer-aided design object types, (b) comprises determining a computer-aided design object type of each computer-aided design object being a member of the set of the actual set of computer-aided design objects, and (c) comprises identifying, as the relevant set of modules, those members of the set of modules that include program instructions relevant for processing computer-aided design objects of each one of the computer-aided design object types other than the at least one of the computer-aided design object types.

8. The computer-implemented method of claim 3, wherein the at least one object comprises at least one graphical object, the plurality of types comprises a plurality of graphical object types, the potential set of objects comprises a potential set of graphical objects, the actual set of objects comprises an actual set of graphical objects excluding all members of the potential set of graphical objects of at least one of the graphical object types, (b) comprises determining a graphical object type of each graphical object being a member of the set of the actual set of graphical objects, and (c) comprises identifying, as the relevant set of modules, those members of the set of modules that include program instructions relevant for processing graphical objects of each one of the graphical object types other than the at least one of the graphical object types.

9. The computer-implemented method of claim 3, wherein the at least one object comprises at least one mathematical formula, the plurality of types comprises a plurality of mathematical formula types, the potential set of objects comprises a potential set of mathematical formulas, the actual set of objects comprises an actual set of mathematical formulas excluding all members of the potential set of mathematical formulas of at least one of the mathematical formula types, (b) comprises determining a mathematical formula type of each mathematical formula being a member of the set of the actual set of mathematical formulas, and (c) comprises identifying, as the relevant set of modules, those members of the set of modules that include program instructions relevant for processing mathematical formulas of each one of the mathematical formula types other than the at least one of the mathematical formula types.

10. The computer-implemented method of claim 3, wherein the at least one object comprises at least one database request, the plurality of types comprises a plurality of database request types, the potential set of objects comprises a potential set of database requests, the actual set of objects comprises an actual set of database requests excluding all members of the potential set of database requests of at least one of the database request types, (b) comprises determining a database request type of each database request being a member of the set of the actual set of database requests, and (c) comprises identifying, as the relevant set of modules, those members of the set of modules that include program instructions relevant for processing database requests of each one of the database request types other than the at least one of the database request types.

11. An electronic device configured to selectively load a set of modules nominally required by a first module for processing a potential set of objects, the device comprising:
a processor; and
a first memory and a second memory each operatively coupled to the processor, the first memory storing the first module, the set of modules, and program instructions executable by the processor to effect:
(a) reception of an indication of an actual set of objects to be processed using the first module, the actual set of objects being a proper subset of the potential set of objects;
(b) performance of an analysis of the members of the actual set of objects;
(c) identification, based on the analysis, of a relevant set of modules actually required by the first module for processing the actual set of objects, the relevant set of modules being a proper subset of the set of modules; and
(d) loading, from the first memory to the second memory, of only those members of the set of modules that are also members of the relevant set of modules.

12. The electronic device of claim 11, wherein (a) comprises reception of an instruction to load the first module, the instruction including the indication of the actual set of objects to be processed using the first module.

13. The electronic device of claim 11, wherein at least one object of each one of a plurality of types is a member of the potential set of objects, the actual set of objects excludes all members of the potential set of objects of at least one of the types, (b) comprises determining a type of each object being a member of the actual set of objects, and (c) comprises identifying, as the relevant set of modules, those members of the set of modules that include program instructions relevant for processing objects of each one of the types other than the at least one of the types.

14. The electronic device of claim 13, wherein identifying those members of the set of modules that include program instructions relevant for processing objects of each one of the types other than the at least one of the types comprises appreciating a predefined mapping from each one of the types to a respective set of modules relevant for processing objects of that one of the types.

15. The electronic device of claim 13, wherein the at least one object comprises at least one file, the plurality of types comprises a plurality of file formats, the potential set of objects comprises a potential set of files, the actual set of objects comprises an actual set of files excluding all members of the potential set of files of at least one of the file formats, (b) comprises determining a file format of each file being a member of the set of the actual set of files, and (c) comprises identifying, as the relevant set of modules, those members of the set of modules that include program instructions relevant for processing files of each one of the file formats other than the at least one of the file formats.

16. The electronic device of claim 13, wherein the at least one object comprises at least one geometry object, the plurality of types comprises a plurality of geometries, the potential set of objects comprises a potential set of geometry objects, the actual set of objects comprises an actual set of geometry objects excluding all members of the potential set of geometry objects of at least one of the geometries, (b) comprises determining a geometry of each geometry object being a member of the set of the actual set of geometry objects, and (c) comprises identifying, as the relevant set of modules, those members of the set of modules that include program instructions relevant for processing geometry objects of each one of the geometries other than the at least one of the geometries.

17. The electronic device of claim 13, wherein the at least one object comprises at least one computer-aided design object, the plurality of types comprises a plurality of computer-aided design object types, the potential set of objects comprises a potential set of computer-aided design objects, the actual set of objects comprises an actual set of computer-aided design objects excluding all members of the potential set of computer-aided design objects of at least one of the computer-aided design object types, (b) comprises determining a computer-aided design object type of each computer-aided design object being a member of the set of the actual set of computer-aided design objects, and (c) comprises identifying, as the relevant set of modules, those members of the set of modules that include program instructions relevant for processing computer-aided design objects of each one of the computer-aided design object types other than the at least one of the computer-aided design object types.

18. The electronic device of claim 13, wherein the at least one object comprises at least one graphical object, the plurality of types comprises a plurality of graphical object types, the potential set of objects comprises a potential set of graphical objects, the actual set of objects comprises an actual set of graphical objects excluding all members of the potential set of graphical objects of at least one of the graphical object types, (b) comprises determining a graphical object type of each graphical object being a member of the set of the actual set of graphical objects, and (c) comprises identifying, as the relevant set of modules, those members of the set of modules that include program instructions relevant for processing graphical objects of each one of the graphical object types other than the at least one of the graphical object types.

19. The electronic device of claim 13, wherein the at least one object comprises at least one mathematical formula, the plurality of types comprises a plurality of mathematical formula types, the potential set of objects comprises a potential set of mathematical formulas, the actual set of objects comprises an actual set of mathematical formulas excluding all members of the potential set of mathematical formulas of at least one of the mathematical formula types, (b) comprises determining a mathematical formula type of each mathematical formula being a member of the set of the actual set of mathematical formulas, and (c) comprises identifying, as the relevant set of modules, those members of the set of modules that include program instructions relevant for processing mathematical formulas of each one of the mathematical formula types other than the at least one of the mathematical formula types.

20. The electronic device of claim 13, wherein the at least one object comprises at least one database request, the plurality of types comprises a plurality of database request types, the potential set of objects comprises a potential set of database requests, the actual set of objects comprises an actual set of database requests excluding all members of the potential set of database requests of at least one of the database request types, (b) comprises determining a database request type of each database request being a member of the set of the actual set of database requests, and (c) comprises identifying, as the relevant set of modules, those members of the set of modules that include program instructions relevant for processing database requests of each one of the database request types other than the at least one of the database request types.

21. A non-transitory computer-readable medium storing program instructions for selectively loading a set of modules nominally required by a first module for processing a potential set of objects, the program instructions being executable by a processor of an electronic device to effect:
(a) reception of an indication of an actual set of objects to be processed using the first module, the actual set of objects being a proper subset of the potential set of objects;
(b) performance of an analysis of the members of the actual set of objects;
(c) identification, based on the analysis, of a relevant set of modules actually required by the first module for processing the actual set of objects, the relevant set of modules being a proper subset of the set of modules; and
(d) loading, from the first memory to the second memory, of only those members of the set of modules that are also members of the relevant set of modules.

22. The non-transitory computer-readable medium of claim 21, wherein (a) comprises reception of an instruction to load the first module, the instruction including the indication of the actual set of objects to be processed using the first module.

23. The non-transitory computer-readable medium of claim 21, wherein at least one object of each one of a plurality of types is a member of the potential set of objects, the actual set of objects excludes all members of the potential set of objects of at least one of the types, (b) comprises determining a type of each object being a member of the actual set of objects, and (c) comprises identifying, as the relevant set of modules, those members of the set of modules that include program instructions relevant for processing objects of each one of the types other than the at least one of the types.

24. The non-transitory computer-readable medium of claim 23, wherein identifying those members of the set of modules that include program instructions relevant for processing objects of each one of the types other than the at least one of the types comprises appreciating a predefined mapping from each one of the types to a respective set of modules relevant for processing objects of that one of the types.

25. The non-transitory computer-readable medium of claim 23, wherein the at least one object comprises at least one file, the plurality of types comprises a plurality of file formats, the potential set of objects comprises a potential set of files, the actual set of objects comprises an actual set of files excluding all members of the potential set of files of at least one of the file formats, (b) comprises determining a file format of each file being a member of the set of the actual set of files, and (c) comprises identifying, as the relevant set of modules, those members of the set of modules that include program instructions relevant for processing files of each one of the file formats other than the at least one of the file formats.

26. The non-transitory computer-readable medium of claim 23, wherein the at least one object comprises at least one geometry object, the plurality of types comprises a plurality of geometries, the potential set of objects comprises a potential set of geometry objects, the actual set of objects comprises an actual set of geometry objects excluding all members of the potential set of geometry objects of at least one of the geometries, (b) comprises determining a geometry of each geometry object being a member of the set of the actual set of geometry objects, and (c) comprises identifying, as the relevant set of modules, those members of the set of modules that include program instructions relevant for processing geometry objects of each one of the geometries other than the at least one of the geometries.

27. The non-transitory computer-readable medium of claim 23, wherein the at least one object comprises at least one computer-aided design object, the plurality of types comprises a plurality of computer-aided design object types, the potential set of objects comprises a potential set of computer-aided design objects, the actual set of objects comprises an actual set of computer-aided design objects excluding all members of the potential set of computer-aided design objects of at least one of the computer-aided design object types, (b) comprises determining a computer-aided design object type of each computer-aided design object being a member of the set of the actual set of computer-aided design objects, and (c) comprises identifying, as the relevant set of modules, those members of the set of modules that include program instructions relevant for processing computer-aided design objects of each one of the computer-aided design object types other than the at least one of the computer-aided design object types.

28. The non-transitory computer-readable medium of claim 23, wherein the at least one object comprises at least one graphical object, the plurality of types comprises a plurality of graphical object types, the potential set of objects comprises a potential set of graphical objects, the actual set of objects comprises an actual set of graphical objects excluding all members of the potential set of graphical objects of at least one of the graphical object types, (b) comprises determining a graphical object type of each graphical object being a member of the set of the actual set of graphical objects, and (c) comprises identifying, as the relevant set of modules, those members of the set of modules that include program instructions relevant for processing graphical objects of each one of the graphical object types other than the at least one of the graphical object types.

29. The non-transitory computer-readable medium of claim 23, wherein the at least one object comprises at least one mathematical formula, the plurality of types comprises a plurality of mathematical formula types, the potential set of objects comprises a potential set of mathematical formulas, the actual set of objects comprises an actual set of mathematical formulas excluding all members of the potential set of mathematical formulas of at least one of the mathematical formula types, (b) comprises determining a mathematical formula type of each mathematical formula being a member of the set of the actual set of mathematical formulas, and (c) comprises identifying, as the relevant set of modules, those members of the set of modules that include program instructions relevant for processing mathematical formulas of each one of the mathematical formula types other than the at least one of the mathematical formula types.

30. The non-transitory computer-readable medium of claim 23, wherein the at least one object comprises at least one database request, the plurality of types comprises a plurality of database request types, the potential set of objects comprises a potential set of database requests, the actual set of objects comprises an actual set of database requests excluding all members of the potential set of database requests of at least one of the database request types, (b) comprises determining a database request type of each database request being a member of the set of the actual set of database requests, and (c) comprises identifying, as the relevant set of modules, those members of the set of modules that include program instructions relevant for processing database requests of each one of the database request types other than the at least one of the database request types.
